(19) United States
(12) Patent Application Publication
(10) Pub. No.: US 2012/0311503 A1
(43) Pub. Date: Dec. 6, 2012

(54) GESTURE TO TRIGGER APPLICATION-PERTINENT INFORMATION

(75) Inventors: Andrew Preston, Sileby (GB); Matthew South, Measham (GB)

(73) Assignee: MICROSOFT CORPORATION, Redmond, WA (US)

(21) Appl. No.: 13/251,640

(22) Filed: Oct. 3, 2011

Related U.S. Application Data
(60) Provisional application No. 61/493,687, filed on Jun. 6, 2011.

(51) Int. Cl. G06F 3/048; G06F 3/033

(52) U.S. Cl. 715/850; 715/863

(57) ABSTRACT

A system is disclosed for interpreting a gesture which triggers application-pertinent information, such as altering a display to bring objects which are farther away into larger and clearer view. In one example, the application is a golfing game in which a user may perform a peer gesture which, when identified by the application, alters the view to display portions of a virtual golf hole nearer to a virtual green into larger and clearer view.

### CLAIM OF PRIORITY

The present application claims priority to U.S. Provisional Patent Application No. 61/493,687, entitled “Gesture to Trigger Application-Pertinent Information,” filed Jun. 6, 2011, which application is incorporated by reference herein in its entirety.

### BACKGROUND

In the past, computing applications such as computer games and multimedia applications used controls to allow users to manipulate game characters or other aspects of an application. Typically such controls are input using, for example, controllers, remotes, keyboards, mice, or the like. More recently, computer games and multimedia applications have begun employing cameras and software gesture recognition engines to provide a natural user interface (“NUI”). With a NUI interface, user gestures are detected, interpreted and used to control game characters or other aspects of an application.

It may be desirable for a user of a graphical user interface such as a NUI system to peer off into the distance. For example, in a golfing game application, a user may wish to see down the fairway and get a closer look at the green.

### SUMMARY

The present technology in general relates to a gesture triggering application pertinent information, such as altering a display to bring objects which are farther away into larger and clearer view.

In one example, the present technology relates to a method for implementing a peer gesture via a natural user interface, comprising: (a) determining if a user has performed a predefined gesture relating to peering into a virtual distance with respect to a scene displayed on a display; and (b) changing the display to create the impression of peering into the virtual distance of the scene displayed on the display upon determining that the user has performed the predefined peering gesture in said step (a).

In another example, the present technology relates to a system for implementing a peer gesture via a natural user interface, comprising: a display for displaying a virtual three-dimensional scene; and a computing device for executing an application, the application generating the virtual three-dimensional scene on the display, and the application including a peer gesture software engine for receiving an indication of a predefined peer gesture, and for causing a view of the three-dimensional scene to change by moving along a path from a first perspective displaying a first point to a second perspective displaying a second point which is virtually distal from the first point.

In a further example, the present technology relates to a processor-readable storage media having processor-readable code embodied on said processor-readable storage media, said processor readable code for programming one or more processors of a hand-held mobile device to perform a method comprising: (a) designing a three-dimensional view of a virtual golf hole in a golf gaming application; (b) determining if a user has performed a predefined gesture relating to peering into a virtual distance with respect to the virtual golf hole displayed on a display; and (c) changing the view of the virtual golf hole by moving along a path from a first point in the foreground of a view to a second point at or nearer to a virtual green of the virtual golf hole to show the second point at or nearer to the virtual green in greater detail.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-1E illustrate example embodiments of a target recognition, analysis, and tracking system with a user playing a game.

FIG. 2 illustrates an example embodiment of a capture device that may be used in a target recognition, analysis, and tracking system.

FIG. 3A illustrates an example embodiment of a computing environment that may be used to interpret one or more gestures in a target recognition, analysis, and tracking system.

FIG. 3B illustrates another example embodiment of a computing environment that may be used to interpret one or more gestures in a target recognition, analysis, and tracking system.

FIG. 4 illustrates a skeletal mapping of a user that has been generated from the target recognition, analysis, and tracking system of FIG. 2.

FIG. 5 is a flowchart of the operation of an embodiment of the present disclosure.

FIG. 6 illustrates sight lines for peering into the distance according to embodiments of the present disclosure.

FIG. 7 is a block diagram showing a gesture recognition engine for determining whether pose information matches a stored gesture.

FIG. 8 is a flowchart showing the operation of the gesture recognition engine.

### DETAILED DESCRIPTION

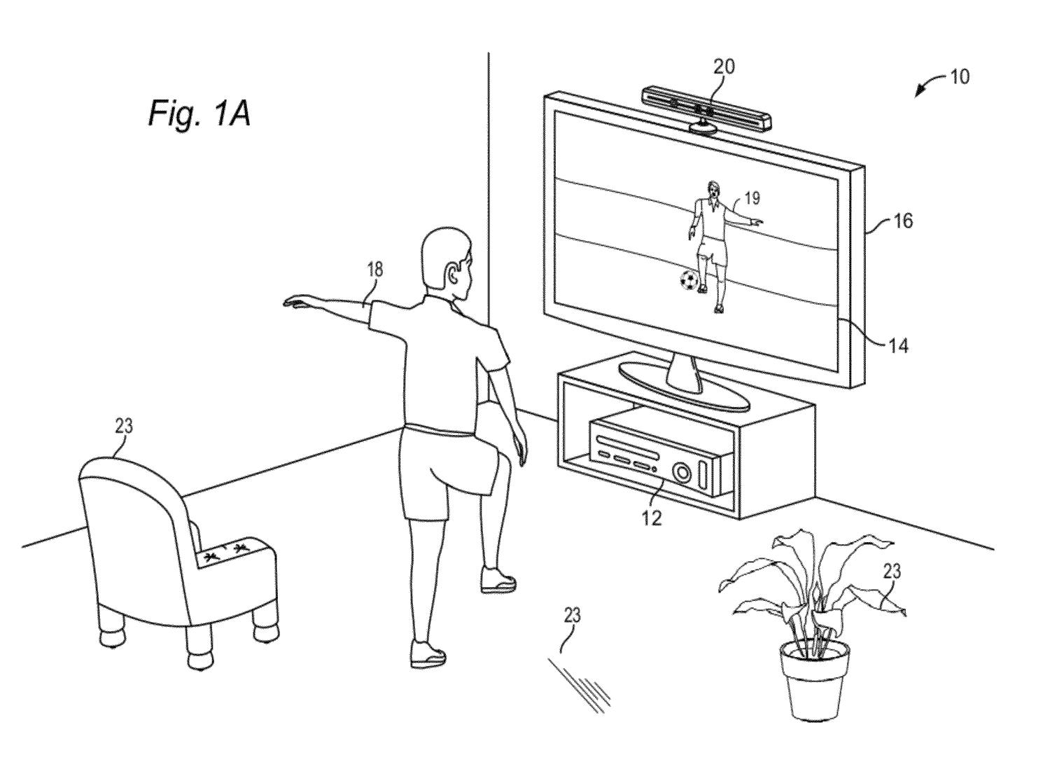

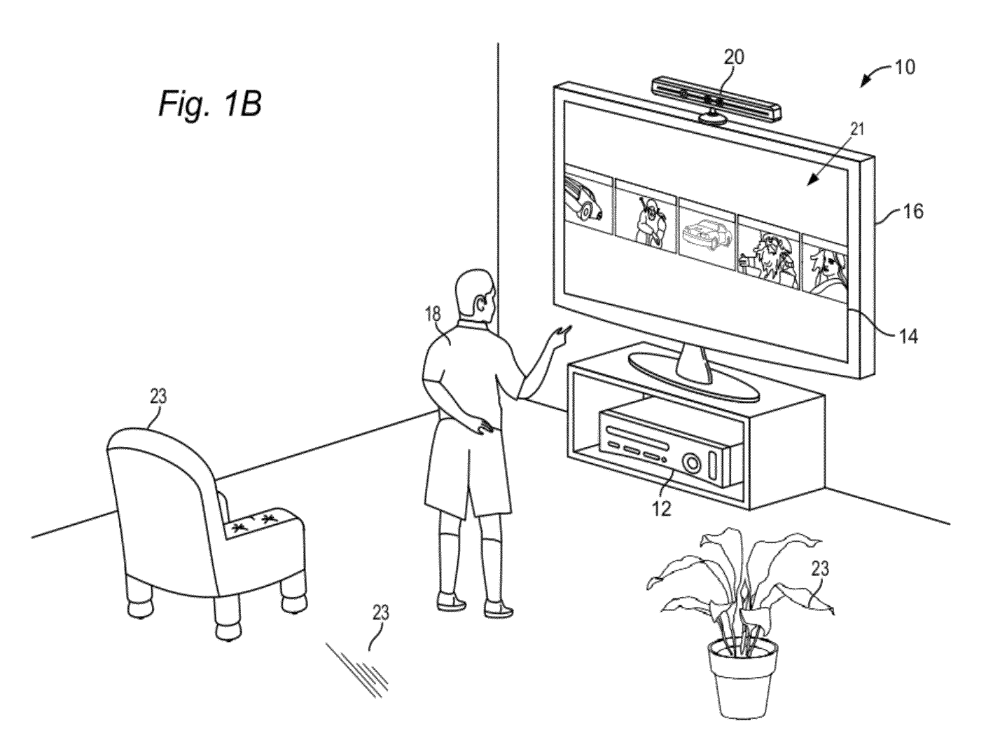

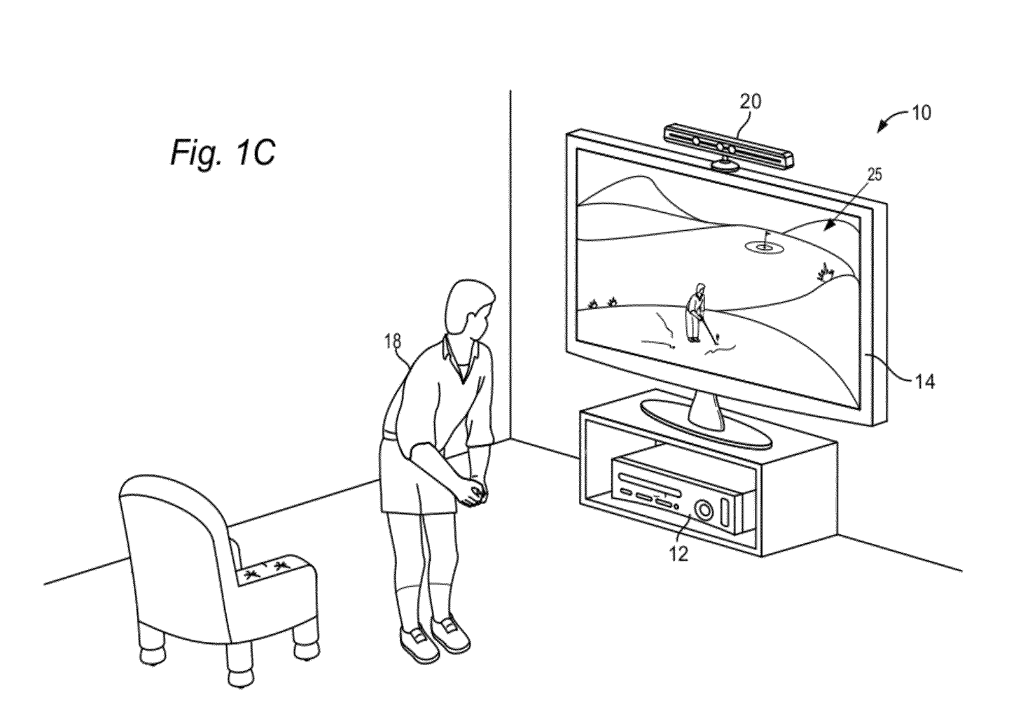

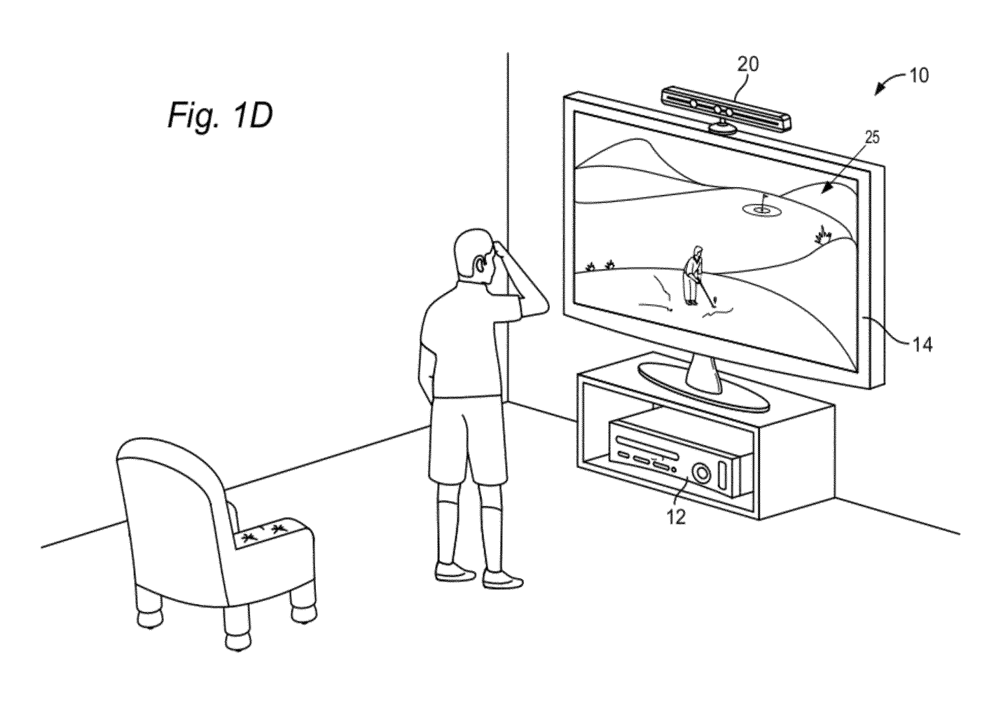

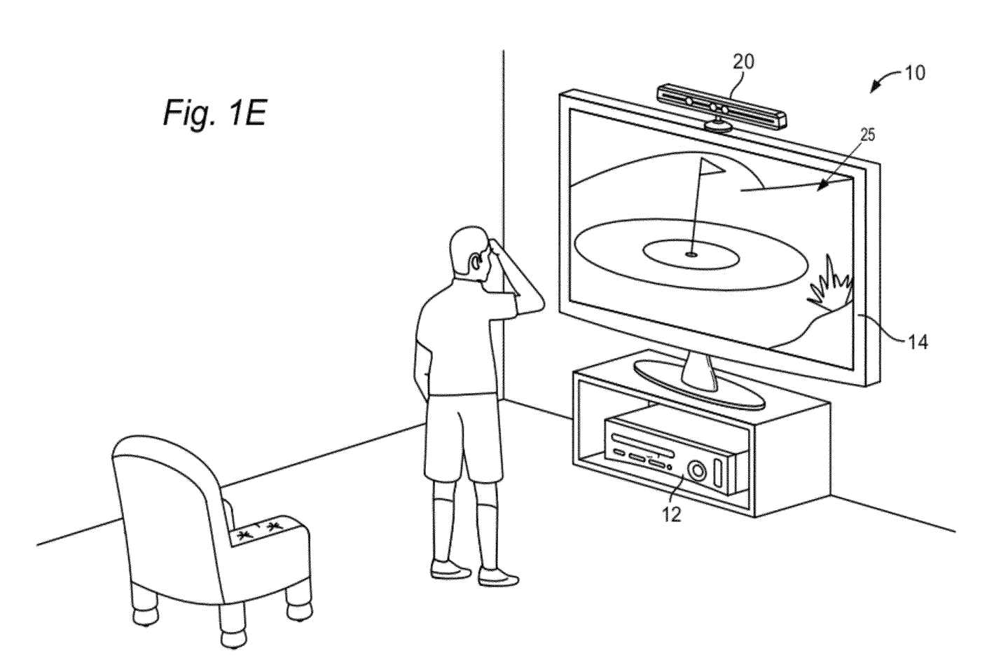

Embodiments of the present technology will now be described with reference to FIGS. 1A-8, which in general relate to a system interpreting a gesture triggering application pertinent information, such as altering a display to bring objects which are farther away into larger and clearer view. Embodiments are described below respect to a golf gaming application. However, the system of the present disclosure can be used in a variety of other gaming and multimedia applications where it may be desirable to view displayed objects that are in the distance more clearly.

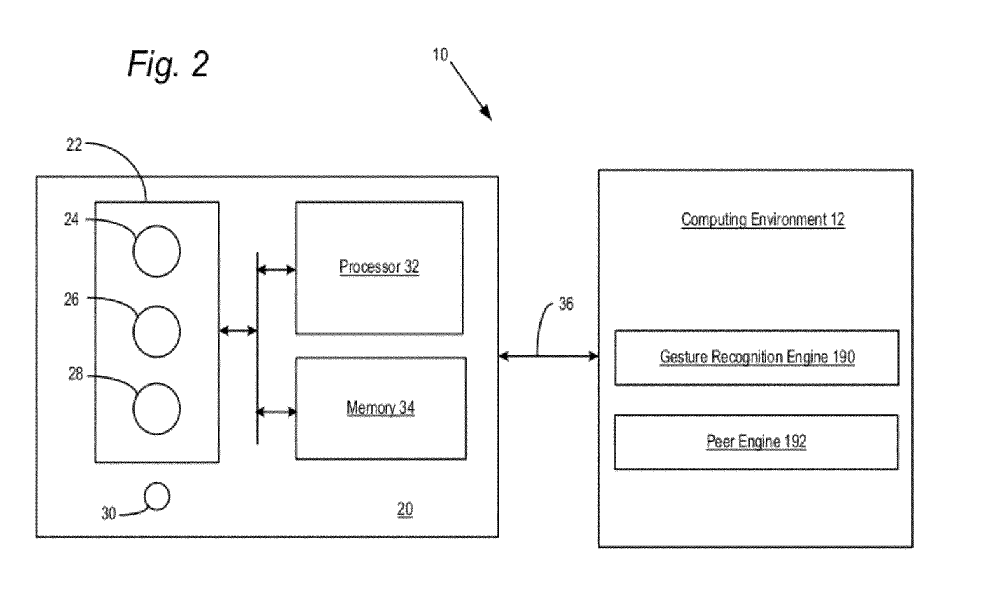

Referring initially to FIGS. 1A-2, the hardware for implementing the present technology includes a target recognition, analysis, and tracking system 10 which may be used to recognize, analyze, and/or track a human target such as the user 18. Embodiments of the target recognition, analysis, and tracking system 10 include a computing environment 12 for executing a gaming or other application. The computing environment 12 may include hardware components and/or software components such that computing environment 12 may be used to execute applications such as gaming and non-gaming applications. In one embodiment, computing environment 12 may include a processor such as a standardized processor, a specialized processor, a microprocessor, or the like that may execute instructions stored on a processor readable storage device for performing processes described herein.

The system 10 further includes a capture device 20 for capturing image and audio data relating to one or more users and/or objects sensed by the capture device. In embodiments, the capture device 20 may be used to capture information relating to body and hand movements and/or gestures and speech of one or more users, which information is received by the computing environment and used to render, interact with and/or control aspects of a gaming or other application. Examples of the computing environment 12 and capture device 20 are explained in greater detail below.

Embodiments of the target recognition, analysis and tracking system 10 may be connected to an audio/visual (A/V) device 16 having a display 14. The device 16 may for example be a television, a monitor, a high-definition television (HDTV), or the like that may provide game or application visuals and/or audio to a user. For example, the computing environment 12 may include a video adapter such as a graphics card and/or an audio adapter such as a sound card that may provide audio/visual signals associated with the game or other application. The A/V device 16 may receive the audio/visual signals from the computing environment 12 and may then output the game or application visuals and/or audio associated with the audio/visual signals to the user 18. According to one embodiment, the audio/visual device 16 may be connected to the computing environment 12 via, for example, an S-Video cable, a coaxial cable, an HDMI cable, a DVI cable, a VGA cable, a component video cable, or the like.

In embodiments, the computing environment 12, the A/V device 16 and the capture device 20 may cooperate to render an avatar or on-screen character 19 on display 14. For example, FIG. 1A shows a user 18 playing a soccer gaming application. The user's movements are tracked and used to animate the movements of the avatar 19. In embodiments, the avatar 19 mimics the movements of the user 18 in real world space so that the user 18 may perform movements and gestures which control the movements and actions of the avatar 19 on the display 14. In FIG. 1B, the capture device 20 is used in a NUI system where, for example, a user 18 is scrolling through and controlling a user interface 21 with a variety of menu options presented on the display 14. In FIG. 1B, the computing environment 12 and the capture device 20 may be used to recognize and analyze movements and gestures of a user's body, and such movements and gestures may be interpreted as controls for the user interface.

FIG. 1C illustrates a user 18 playing a golfing game running on computing environment 12. The onscreen avatar 19 tracks and mirrors a user's movements. A display of a virtual golf hole is displayed on display 14. As a user is playing the golfing game, he or she may desire to peer into the distance. For example, the user may wish to get a closer, clearer look at the green, or a portion of the hole that is off in the distance.

In accordance with the present disclosure, the user may perform a predefined gesture, referred to herein as a peer gesture. An example of a peer gesture is shown in FIG. 1D. In this example, the user cups his or her eyes with his or her hand, though it is understood that other gestures may be used as the peer gesture in further embodiments. As shown in FIG. 1E, upon performing the gesture, the display zooms into the distance, enlarging a view of objects or things in the distance and making them more clear.

Suitable examples of a system 10 and components thereof are found in the following co-pending patent applications, all of which are hereby specifically incorporated by reference: U.S. patent application Ser. No. 12/475,094, entitled “Environment and/or Target Segmentation,” filed May 29, 2009; U.S. patent application Ser. No. 12/511,850, entitled “Auto Generating a Visual Representation,” filed Jul. 29, 2009; U.S. patent application Ser. No. 12/474,655, entitled “Gesture Tool,” filed May 29, 2009; U.S. patent application Ser. No. 12/603,437, entitled “Pose Tracking Pipeline,” filed Oct. 21, 2009; U.S. patent application Ser. No. 12/475,308, entitled “Device for Identifying and Tracking Multiple Humans Over Time,” filed May 29, 2009, U.S. patent application Ser. No. 12/575,388, entitled “Human Tracking System,” filed Oct. 7, 2009; U.S. patent application Ser. No. 12/422,661, entitled “Gesture Recognizer System Architecture,” filed Apr. 13, 2009; U.S. patent application Ser. No. 12/391,150, entitled “Standard Gestures,” filed Feb. 23, 2009; and U.S. patent application Ser. No. 12/474,655, entitled “Gesture Tool,” filed May 29, 2009.

FIG. 2 illustrates an example embodiment of the capture device 20 that may be used in the target recognition, analysis, and tracking system 10. In an example embodiment, the capture device 20 may be configured to capture video having a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight. X and Y axes may be defined as being perpendicular to the Z axis. The Y axis may be vertical and the X axis may be horizontal. Together, the X, Y and Z axes define the 3-D real world space captured by capture device 20.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28.

In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device 20 to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as a grid pattern or a stripe pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the capture device 20 to a particular location on the targets or objects.

According to another embodiment, the capture device 20 may include two or more physically separated cameras that may view a scene from different angles, to obtain visual stereo data that may be resolved to generate depth information. In another example embodiment, the capture device 20 may use point cloud data and target digitization techniques to detect features of the user.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image camera component 22 and the processor 32. According to another embodiment, the memory component 34 may be integrated into the processor 32 and/or the image camera component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28. With the aid of these devices, a partial skeletal model may be developed in accordance with the present technology, with the resulting data provided to the computing environment 12 via the communication link 36.

The computing environment 12 may further include a gesture recognition engine 190 for recognizing gestures, such as the peer gesture as explained above and below. In accordance with the present system, the computing environment 12 may further include a peer engine 192 as explained below.

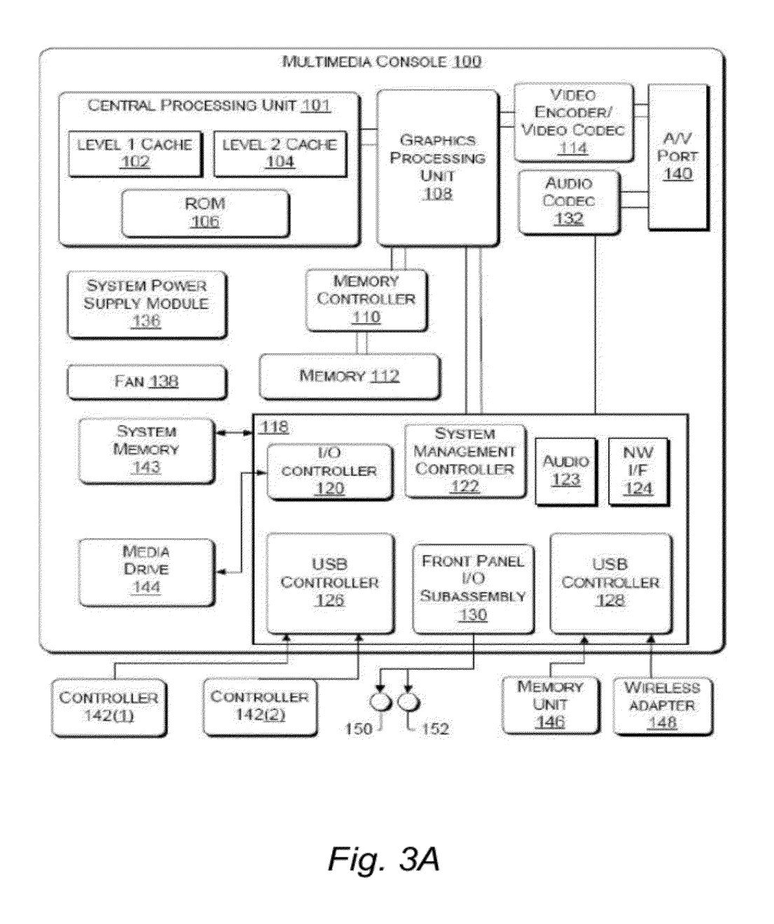

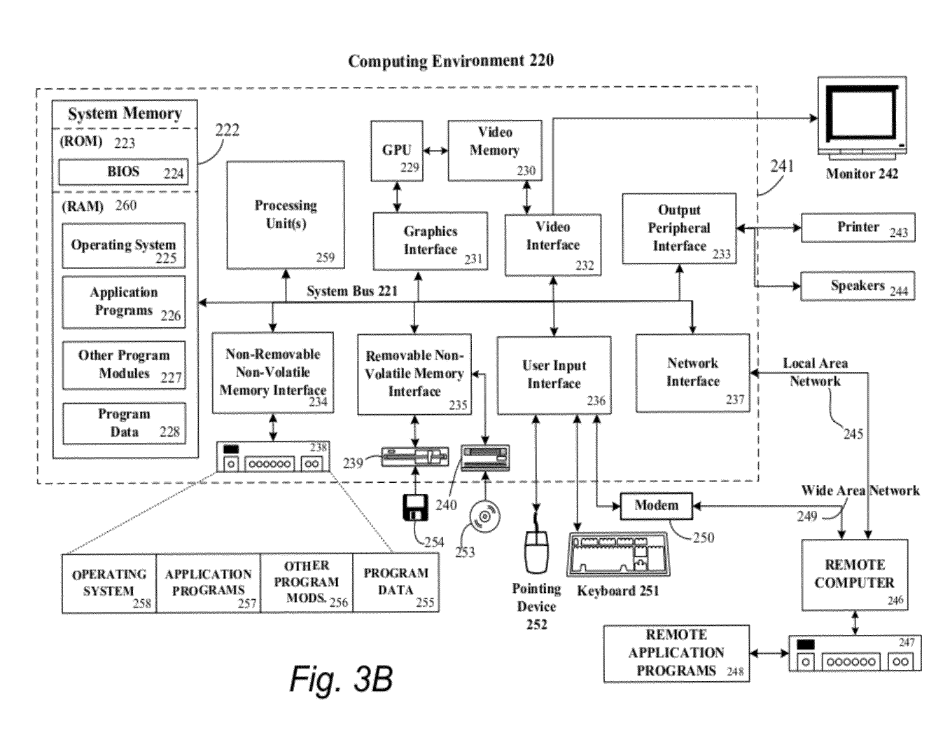

FIG. 3A illustrates an example embodiment of a computing environment that may be used to interpret one or more gestures in a target recognition, analysis, and tracking system. The computing environment such as the computing environment 12 described above with respect to FIGS. 1A-2 may be a multimedia console 100, such as a gaming console. As shown in FIG. 3A, the multimedia console 100 has a central processing unit (CPU) 101 having a level 1 cache 102, a level 2 cache 104, and a flash ROM 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the GPU 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM.

The multimedia console 100 includes an I/O controller 120, a system management controller 122, an audio processing unit 123, a network interface controller 124, a first USB host controller 126, a second USB host controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of the application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches. The cameras 26, 28 and capture device 20 may define additional input devices for the console 100.

FIG. 3B illustrates another example embodiment of a computing environment 220 that may be the computing environment 12 shown in FIGS. 1A-2 used to interpret one or more gestures in a target recognition, analysis, and tracking system. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 3B, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as ROM 223 and RAM 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 3B illustrates operating system 225, application programs 226, other program modules 227, and program data 228.

The computer 241 may also include other removable/non-removable, volatile/nonvolatile computer storage media. By way of example only, FIG. 3B illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 3B, provide storage of computer readable instructions, data structures, program modules and other data for the computer 241. In FIG. 3B, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and a pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through an output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 3B. The logical connections depicted in FIG. 3B include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 3B illustrates remote application programs 248 as residing on memory device 247. It will be appreciated that the network connections shown are exemplary and other means of establishing a communications link between the computers may be used.

The computing environment 12 in conjunction with the capture device 20 may generate a computer model of a user's body position each frame. One example of such a pipeline which generates a skeletal model of one or more users in the field of view of capture device 20 is disclosed for example in U.S. patent application Ser. No. 12/876,418, entitled “System For Fast, Probabilistic Skeletal Tracking,” filed Sep. 7, 2010, which application is incorporated by reference herein in its entirety.

The skeletal model may then be provided to the computing environment 12 such that the computing environment may track the skeletal model and render an avatar associated with the skeletal model. The computing environment may further determine which controls to perform in an application executing on the computer environment based on, for example, gestures of the user that have been recognized from the skeletal model. For example, as shown, in FIG. 2, the computing environment 12 may include a gesture recognition engine 190. The gesture recognition engine 190 is explained hereinafter, but may in general include a collection of gesture filters, each comprising information concerning a gesture that may be performed by the skeletal model (as the user moves).

The data captured by the cameras 26, 28 and device 20 in the form of the skeletal model and movements associated with it may be compared to the gesture filters in the gesture recognition engine 190 to identify when a user (as represented by the skeletal model) has performed one or more gestures. Those gestures may be associated with various controls of an application. Thus, the computing environment 12 may use the gesture recognition engine 190 to interpret movements of the skeletal model and to control an application based on the movements. For example, in the context of the present disclosure, the gesture recognition engine may recognize when a user is performing a peer gesture to peer into the virtual distance of the scene displayed on display 14.

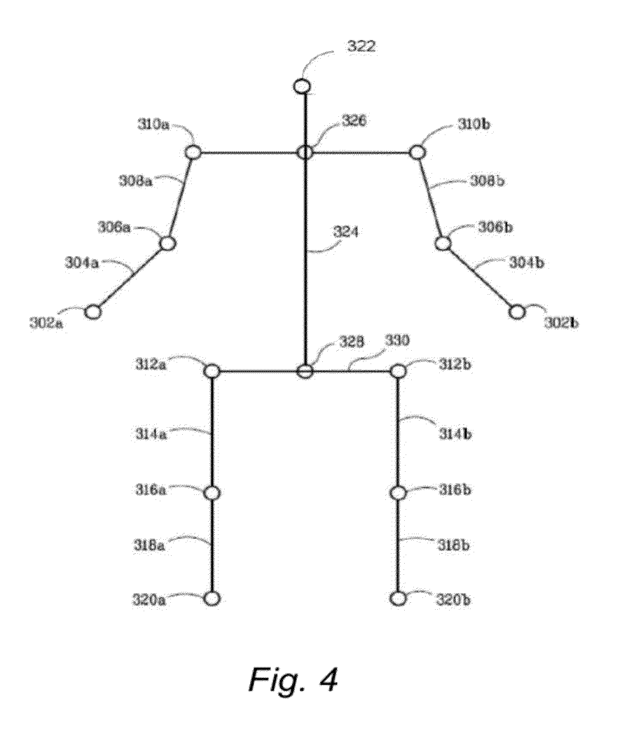

FIG. 4 depicts an example skeletal mapping of a user that may be generated from the capture device 20. In this embodiment, a variety of joints and bones are identified: each hand 302, each forearm 304, each elbow 306, each bicep 308, each shoulder 310, each hip 312, each thigh 314, each knee 316, each foreleg 318, each foot 320, the head 322, the mid spine 324, the top 326 and the bottom 328 of the spine, and the waist 330. Where more points are tracked, additional features may be identified, such as the bones and joints of the fingers or toes, or individual features of the face, such as the nose and eyes.

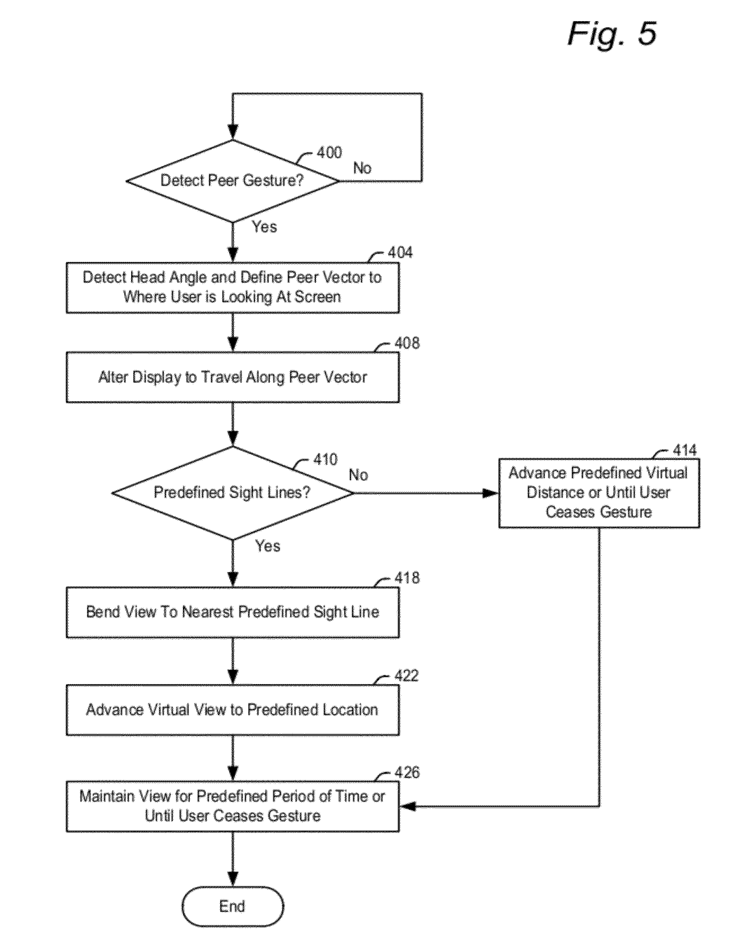

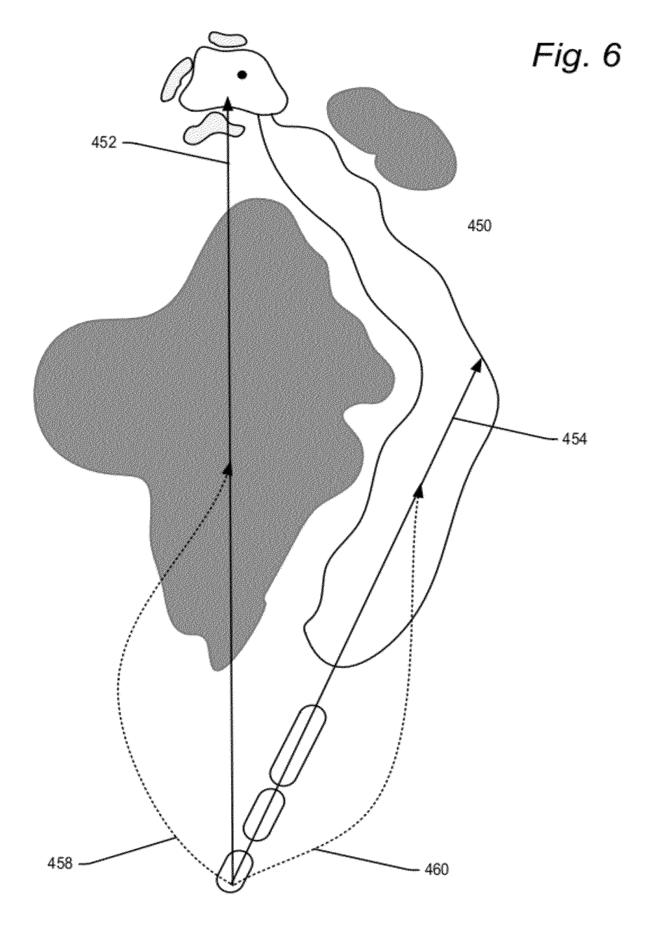

The peer gesture engine 192 will now be explained in greater detail with reference to the flowchart of FIG. 5 and the illustration of FIG. 6. As noted above, the peer gesture may be performed by a user moving his hand into a predefined position with respect to his head as shown in FIGS. 1D and 1E. In particular, the user may cups his eyes with his hand. When performing the peer gesture, the hand may generally be in an x-z plane with respect to the capture device 20 with the index finger near or in contact with the forehead (as if shielding the sun from his or her eyes). In contexts other than a gaming situation or use of a NUI system, this gesture often connotes that the performer is peering into the distance to get a better view of objects that are far off Despite this real world connotation and intuitive adaptation as a predefined gesture in a NUI application, it is understood that a wide variety of other gestures may alternatively be used as a peer gesture according to the present disclosure. The peer gesture may be performed with either hand.

In step 400, the gesture recognition engine 190 detects whether the peer gesture was performed as explained below. In embodiments, the gesture recognition engine may require that the peer gesture is performed for some predetermined period of time before executing the peer steps. This prevents other motions where a user touches his face or forehead from incorrectly being interpreted as a peer gesture.

If the peer gesture is detected, the peer engine determines the user's head orientation relative to the capture device 20 and display 14 in step 404. This information is available from the skeletal model generated by the body recognition pipeline. The peer gesture interprets this as the direction in which the user wishes to look. It therefore creates a peer vector in that direction. The system may ignore the specific direction where a user is looking in alternative embodiments. In these embodiments, upon detecting the peer gesture, the system ignores where the user's head is pointing. Upon a peer gesture, the in-game camera view moves forward from its current viewing direction, which may be directly behind the player's avatar. In a further embodiment, if the player wishes to view in another direction they can side step in the real world to adjust their aim around the ball, and hence the camera orientation, and then trigger the peer gesture. This is analogous to a user peering into the display 14 like they would through a window, rather than along their own eye line in the real world.

In step 408, the display is altered to in effect travel along the peer vector into the virtual scene. As one example, if a user is looking down the fairway of a golf hole toward the green, the view may change to in effect travel down the fairway to the green, where the user can view aspects of the green in greater detail. The user may opt to peer at other aspects of a golf hole or other scenes in further embodiments. In further embodiments, the peer view will depend on where the player avatar is positioned on the virtual geometric ground model. For example, in a golf game, the route which is taken is based on where the player avatar is on the course. The virtual camera will go forward initially and try to match the best (nearest) predefined path. Thus, for example, if the player is on the fairway, the camera will follow the fairway path to the green. If the player is in the rough, the camera will follow the shortcut path to the green, and so on.

In embodiments, there may be predefined sight lines. For example, referring to the illustration of a golf hole 450 in FIG. 6, there exists a pair of predefined sight lines 452 and 454. If no such predefined sight lines exist in step 410, the peer engine 192 may advance a predefined distance into the virtual scene and then stop. Alternatively, the peer engine may advance until the user ceases the gesture (drops his hand away). As noted above, there may always be a predefined path, if only a straight line between the current avatar position and the destination (for example, the flag in a golf game). In such instances, step 410 may be omitted.

On the other hand, if there are predefined sight lines as shown in FIG. 6, the display may change by gradually bending away from the peer vector as the view advances into the scene toward the nearest predefined sight line. Once at the sight line, the peer engine may change the display to advance along the sight line to a predefined location at the end of the sight line in step 422.

Thus, for example, where a user's avatar 19 is at the tee box of a golf hole, the user may perform the peer gesture while looking at the display in the direction of line 458. In this case, the view may advance initially along line 458, but then bend toward sight line 452. Once at sight line 452, the view advances until the user is shown the green for that hole. Alternatively, the user may perform the peer gesture while looking at the display in the direction of line 460. In this case, the view may advance initially along line 460, but then bend toward sight line 454. Once at sight line 454, the view advances until the user is shown the portion of the hole which dog-legs (turns) left.

Once at the peer destination (either at step 414 or 422), the display view may stay on that location for a predefined period of time (step 426), or until the user ceases the peer gesture, at which point the display view may be returned to the starting point from where the peer gesture was initially performed.

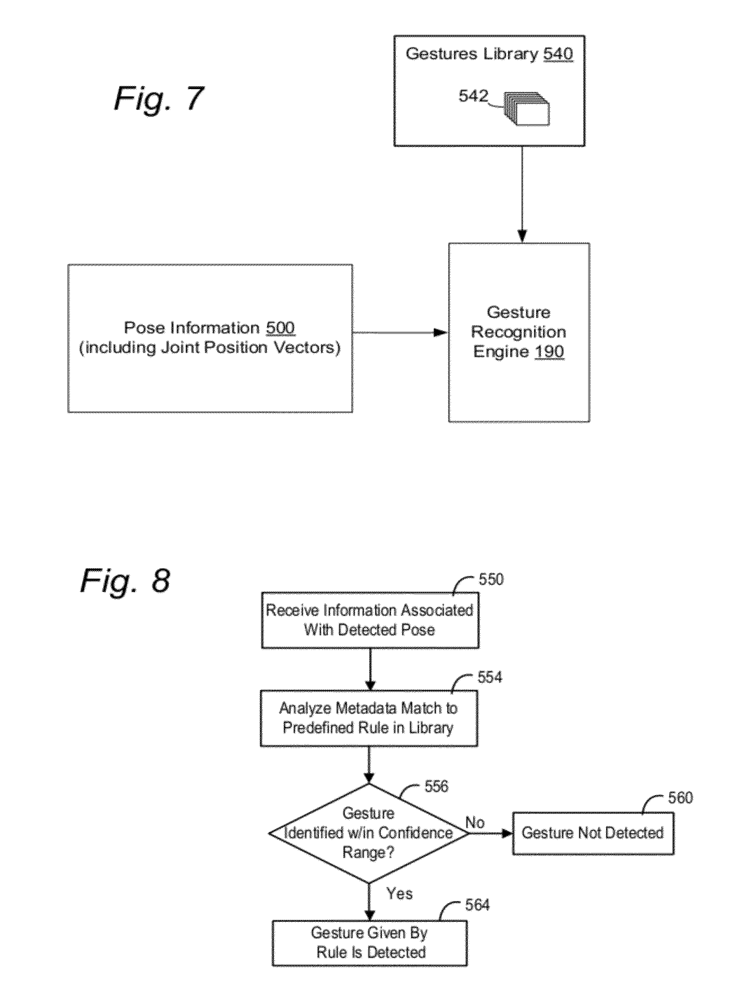

The gesture recognition engine 190 for recognizing the peer gesture and other predefined gestures will now be explained with reference to FIGS. 7 and 8. Those of skill in the art will understand a variety of methods of analyzing user body movements and position to determine whether the movements/position conform to a predefined gesture. Such methods are disclosed for example in the above incorporated application Ser. No. 12/475,308, as well as U.S. Patent Application Publication No. 2009/0074248, entitled “Gesture-Controlled Interfaces For Self-Service Machines And Other Applications,” which publication is incorporated by reference herein in its entirety. However, in general, user positions and movements are detected by the capture device 20. From this data, joint position vectors may be determined. The joint position vectors may then passed to the gesture recognition engine 190, together with other pose information. The operation of gesture recognition engine 190 is explained in greater detail with reference to the block diagram of FIG. 7 and the flowchart of FIG. 8.

The gesture recognition engine 190 receives pose information 500 in step 550. The pose information may include a great many parameters in addition to joint position vectors. Such additional parameters may include the x, y and z minimum and maximum image plane positions detected by the capture device 20. The parameters may also include a measurement on a per-joint basis of the velocity and acceleration for discrete time intervals. Thus, in embodiments, the gesture recognition engine 190 can receive a full picture of the position and kinetic activity of all points in the user's body.

The gesture recognition engine 190 analyzes the received pose information 500 in step 554 to see if the pose information matches any predefined rule 542 stored within a gestures library 540. A stored rule 542 describes when particular positions and/or kinetic motions indicated by the pose information 500 are to be interpreted as a predefined gesture. In embodiments, each gesture may have a different, unique rule or set of rules 542. Each rule may have a number of parameters (joint position vectors, maximum/minimum position, change in position, etc.) for one or more of the body parts shown in FIG. 4. A stored rule may define, for each parameter and for each body part 302 through 330 shown in FIG. 4, a single value, a range of values, a maximum value, a minimum value or an indication that a parameter for that body part is not relevant to the determination of the gesture covered by the rule. Rules may be created by a game author, by a host of the gaming platform or by users themselves.

The gesture recognition engine 190 may output both an identified gesture and a confidence level which corresponds to the likelihood that the user's position/movement corresponds to that gesture. In particular, in addition to defining the parameters required for a gesture, a rule may further include a threshold confidence level required before pose information 500 is to be interpreted as a gesture. Some gestures may have more impact as system commands or gaming instructions, and as such, require a higher confidence level before a pose is interpreted as that gesture. The comparison of the pose information against the stored parameters for a rule results in a cumulative confidence level as to whether the pose information indicates a gesture.

Once a confidence level has been determined as to whether a given pose or motion satisfies a given gesture rule, the gesture recognition engine 190 then determines in step 556 whether the confidence level is above a predetermined threshold for the rule under consideration. The threshold confidence level may be stored in association with the rule under consideration. If the confidence level is below the threshold, no gesture is detected (step 560) and no action is taken. On the other hand, if the confidence level is above the threshold, the user's motion is determined to satisfy the gesture rule under consideration, and the gesture recognition engine 190 returns the identified gesture.

Given the above disclosure, it will be appreciated that a great many gestures may be identified using joint position vectors in addition to the peer gesture. As one of many examples, the user may lift and drop each leg 312-320 to mimic walking without moving.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

1. A method for implementing a peer gesture via a natural user interface, comprising:
(a) determining if a user has performed a predefined gesture relating to peering into a virtual distance with respect to a scene displayed on a display; and
(b) changing the display to create the impression of peering into the virtual distance of the scene displayed on the display upon determining that the user has performed the predefined peering gesture in said step (a).

2. The method of claim 1, wherein said step of determining if a user has performed a predefined gesture relating to peering into a virtual distance comprises the step of determining whether the user has positioned one or two hands in a predetermined position with respect to the user's face.

3. The method of claim 2, wherein said step of determining if a user has performed a predefined gesture relating to peering into a virtual distance comprises the step of determining whether the user has cupped the user's eyes with one or both hands.

4. The method of claim 1, wherein said step of determining if a user has performed a predefined gesture relating to peering into a virtual distance comprises the step of determining whether the user has performed the predefined gesture for a predetermined period of time.

5. The method of claim 1, wherein said step of changing the display to create the impression of peering into the virtual distance comprises the step of enlarging virtual objects on the display to create the impression of viewing the enlarged virtual objects from a closer perspective.

6. A system for implementing a peer gesture via a natural user interface, comprising:
(a) a display for displaying a virtual three-dimensional scene; and
(b) a computing device for executing an application, the application generating the virtual three-dimensional scene on the display, and the application including a peer gesture software engine for receiving an indication of a predefined peer gesture, and for causing a view of the three-dimensional scene to change by moving along a path from a first perspective displaying a first point to a second perspective displaying a second point which is virtually distal from the first point.

7. A system as recited in claim 6, wherein the path along which the view is of the scene is changed is at least substantially a predefined path to the second point.

8. A system as recited in claim 6, wherein the path along which the view is of the scene is changed is a path which initially moves to a nearest predefined path and then along the predefined path, to the second point.

9. A system as recited in claim 8, wherein the application includes two or more predefined paths for a virtual three-dimensional scene displayed on the display.

10. A system as recited in claim 9, wherein each of the two or more predefined paths includes a different second point.

11. A system as recited in claim 6, wherein the path along which the view is of the scene is changed is determined by a detected direction of the user's head.

12. A system as recited in claim 6, wherein the path along which the view is of the scene is changed is determined by a peer vector representing a vector straight out from a face of a user.

13. A system as recited in claim 6, the peer gesture software engine further receiving an indication that a user has stopped performing the predefined peer gesture, and returning the view of the virtual three-dimensional scene to the view from the first point a predetermined period of time after the peer gesture software engine receives an indication that the user has stopped performing the predefined peer gesture.

14. A system as recited in claim 6, further comprising a gesture recognition software engine for recognizing performance of the predefined peer gesture.

15. A processor-readable storage media having processor-readable code embodied on said processor-readable storage media, said processor readable code for programming one or more processors of a computing device to perform a method comprising:
(a) providing a three-dimensional view of a virtual golf hole in a golf gaming application;
(b) determining if a user has performed a predefined gesture relating to peering into a virtual distance with respect to the virtual golf hole displayed on a display; and
(c) changing the view of the virtual golf hole by moving along a path from a first point in the foreground of a view to a second point at or nearer to a virtual green of the virtual golf hole to show the second point at or nearer to the virtual green in greater detail.

16. A processor-readable storage media as recited in claim 15, wherein said step of determining if a user has performed a predefined gesture relating to peering into a virtual distance comprises the step of determining whether the user has cupped the user's eyes with one or both hands.

17. A processor-readable storage media as recited in claim 15, wherein said step of determining if a user has performed a predefined gesture relating to peering into a virtual distance comprises the step of determining whether the user has cupped the user's eyes with one or both hands.

18. A processor-readable storage media as recited in claim 15, wherein the path along which the view is of the golf hole is changed is a path which initially moves to a nearest predefined path and then along the predefined path, at or nearer to the virtual green.

19. A processor-readable storage media as recited in claim 15, wherein the view of the second point at or nearer to a virtual green is maintained for a predetermined period of time and then returning the view to the first point.

20. A processor-readable storage media as recited in claim 15, wherein the view of the second point at or nearer to a virtual green is maintained until determining that the user has stopped performing the predefined gesture and then returning the view to the first point.
